(19) United States
(12) Patent Application Publication
(10) Pub. No.: US 2014/0310023 A1
(43) Pub. Date: Oct. 16, 2014

(54) SYSTEM FOR PREPARATION AND STORAGE OF DIGITAL REPORTS AND EXAMINATION RESULTS OF CLINICAL AND ULTRASOUND VASCULAR CARTOGRAPHY

(71) Applicant: MARCONDES ANTONIO de MEDEIROS FIGUEIREDO, Uberlandia (BR)

(72) Inventor: MARCONDES ANTONIO de MEDEIROS FIGUEIREDO, Uberlandia (BR)

(21) Appl. No.: 13/860,065

(22) Filed: Apr. 10, 2013

(51) Int. Cl. G06F 19/00

(52) U.S. Cl. CPC G06F 19/321; G06F 19/322
USPC 705/3

(57) ABSTRACT

System for preparation and storage of digital reports and examination results of clinical and ultrasound vascular cartography refers to a system (1) with stationary tools (2) and special tools (3) to draw in the schematic of the modules: a clinic cartography (4), a venous cartography (5) and an arterial cartography (6), with storing in a database (7), which patient history can be accessed anytime by using the global communication network (8).

### BACKGROUND

This Patent of Invention request relates to an unprecedented system for preparation and storage of digital reports and examination results of clinical and ultrasound vascular cartography, of a system specially designed with tools that allow for medical consultation and ultrasound, register through digital drawings, the visible varicosities of the lower limbs of patients with venous disease and using a vascular ultrasound device, allowing the elaborating of an ultrasound report of the circulatory system, recording irregularities in schematic systems, and venous blood, storing this information in a database capable to be accessed from the patient's history at any time using the global communication network.

The innovative system has the medical field as a scope, more specifically for cartography vascular clinical examination and issuing reports of patients with venous insufficiency, among others.

The cartography consists on a vascular system that aims to map the vascular pathologies, of which we highlight three basic functions.

Clinical cartography: allows after the clinical examination of patients with venous insufficiency of the lower limbs, to draw their varicose veins (spider veins, varicose veins and reticular truncal), lay out the ochrodermatitis, and draw a scar or ulcer, recording the physical examination of the patient. And accessory tools for changing colors, rubber, straight lines, undo, free brush and arrows to make notes in the schema.

Venous ultrasonography cartography: allows issuing reports of venous ultrasonography cartography and research of thrombosis of the lower and upper limbs, vena cava and iliac arteries. Through specific tools that allows the draw of schematics for late or early thrombosis, reflux, aneurysms, stents. Thus, recording the award in a scheme. And accessory tools for changing colors, rubbers for erasing, undo, free brush and arrows to make notes in the schema.

Arterial ultrasonography cartography: And accessory tools for changing colors, eraser to erase, undo, free brush sizes and with three arrows to make annotations in the schema. Ultrasound arterial cartography: allows issuing reports ultrasound of carotid and vertebral arteries, abdominal aorta and iliac arteries, lower extremities and upper digestive tract arteries. Through specific tools, that let you draw the diagrams an atheroma plaque, stent aneurysms (saccular, or fusiform pseudo aneurysm), fistulas, vision board cross and kinking. And accessory tools for changing colors, rubbers for erasing, undo, free brush and arrows to make notes in the schema.

Currently, the clinical examination for vascular cartography and issuing reports of patients with venous insufficiency, is made solely on printed papers where the physician draws by hand, on their own sheet without the option of erasing a drawing launched wrong, storage is done in cabinets occupying physical space, and cannot be sent in real time to the patient or even to another healthcare professional.

Moreover, manufacturers more keen on the market's needs seek to develop systems that provide greater safety, simple handling and practical, in accordance with the focus of this request for privilege, have gained ground in the consumer market.

Aware of the technicians, its gaps and limitations, the inventor, after a complete study and research, has created the system for preparation and storage of digital reports and examination results of clinical and ultrasound vascular cartography herein, treating of a system specially designed with tools that allow for medical consultation and ultrasound, register through digital drawings, the visible varicosities of the lower limbs of patients with venous disease and using a vascular ultrasound device, allowing the elaborating of an ultrasound report of the circulatory system, recording irregularities in schematic systems, and venous blood, storing this information in a database capable to be accessed from the patient's history at any time using the global communication network.

The system for preparation and storage of digital reports and examination results of clinical and ultrasound vascular cartography conceptually aims the possibility of drafting and editing reports and clinical examinations of vascular cartography with drawings and pictures, which can be accessed anywhere in the world, only with restricted access.

In the system for preparation and storage of digital reports and examination results of clinical and ultrasound vascular cartography there are cartography schemes that are scopes drawings of the system: venous and arterial region to be studied. The cartography scheme is divided into three modules: Clinical Cartography (clinical module), Venous Ultrasound Cartography (venous module) and Ultrasound Arterial Cartography (arterial module).

In the system for preparation and storage of digital reports and examination results of clinical and ultrasound vascular cartography clinical cartography, clinical module is a schematic of the lower limbs (right and left), lateral, anterior, medial and posterior to the record of varicose veins, spider veins, varicose veins and reticular trunk varicose veins and also the record of the sequels of chronic venous disease: ochrodermatitis.

In the system for preparation and storage of digital reports and examination results of clinical and ultrasound vascular cartography the venous ultrasound cartography, venous module consists of lower limb venous cartography (left and right), search thrombosis in the lower and upper limb (left and right).

In the system for preparation and storage of digital reports and examination results of clinical and ultrasound vascular cartography the arterial ultrasonography cartography, arterial module is composed by: abdominal aorta and iliac arteries of the digestive tract, carotid and vertebral, lower limbs, upper limbs.

The system for preparation and storage of digital reports and examination results of clinical and ultrasound vascular cartography ensures greater flexibility in reporting clinical reports as well, opening the possibility to store in a safe place for consultation the patient's history in future event.

The system for preparation and storage of digital reports and examination results of clinical and ultrasound vascular cartography allows the viewing of the report/clinical examination from any mobile device with internet access and even accepts that the system itself generates protected files against changes allowing the physician in real time forward an email address to anyone.

In short, the system for the preparation and storage of digital scans and reports claimed advantages include more prevalent:

Allows the preparation of exams and reports with digital drawings on schemas, cartography the situation of vascular diseases of the patients;

User friendly tools;

Increased efficiency in pathology reproduction;

Easy visualization and understanding of examinations and reports;

Ensures file generation for digital transmission and visualization in real time;

Promotes the storage of information in an encrypted database with Access granted only by personal username and password;

The storage is done through virtual database;

Simple constructiveness;

Great cost-benefit ratio;

The examinations and reports can be viewed at anytime from anywhere in the world from mobile devices with internet Access.

Next, the invention is explained with reference to the accompanying drawings in which are shown illustrative and not limited:

### BRIEF DESCRIPTION OF THE FIGURES

FIG. 1—Front view of the system for the preparation and storage of reports and examinations clinical and ultrasound digital vascular cartography, showing the layout of the arterial cartography from the abdominal aorta and iliac arteries, with the side tools;

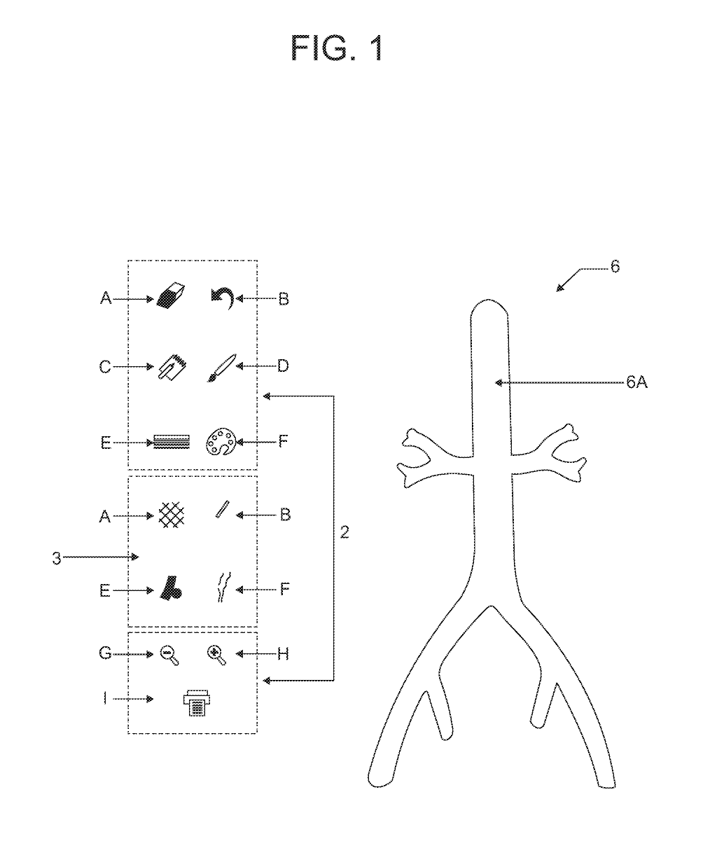

FIG. 2—Front view of the system for the preparation and storage of reports and examinations clinical and ultrasound digital vascular cartography, showing the fixed tools and its sub tools;

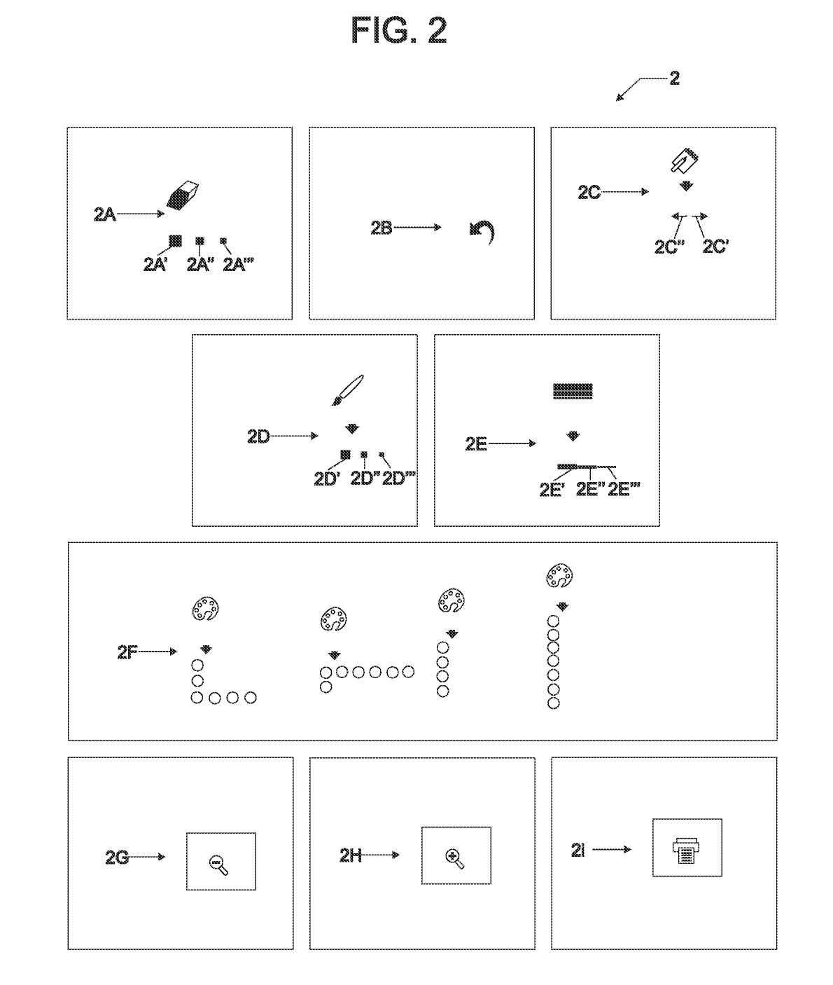

FIG. 3—Front view of the system for the preparation and storage of reports and examinations clinical and ultrasound digital vascular cartography, showing the special specific tools and its sub tools;

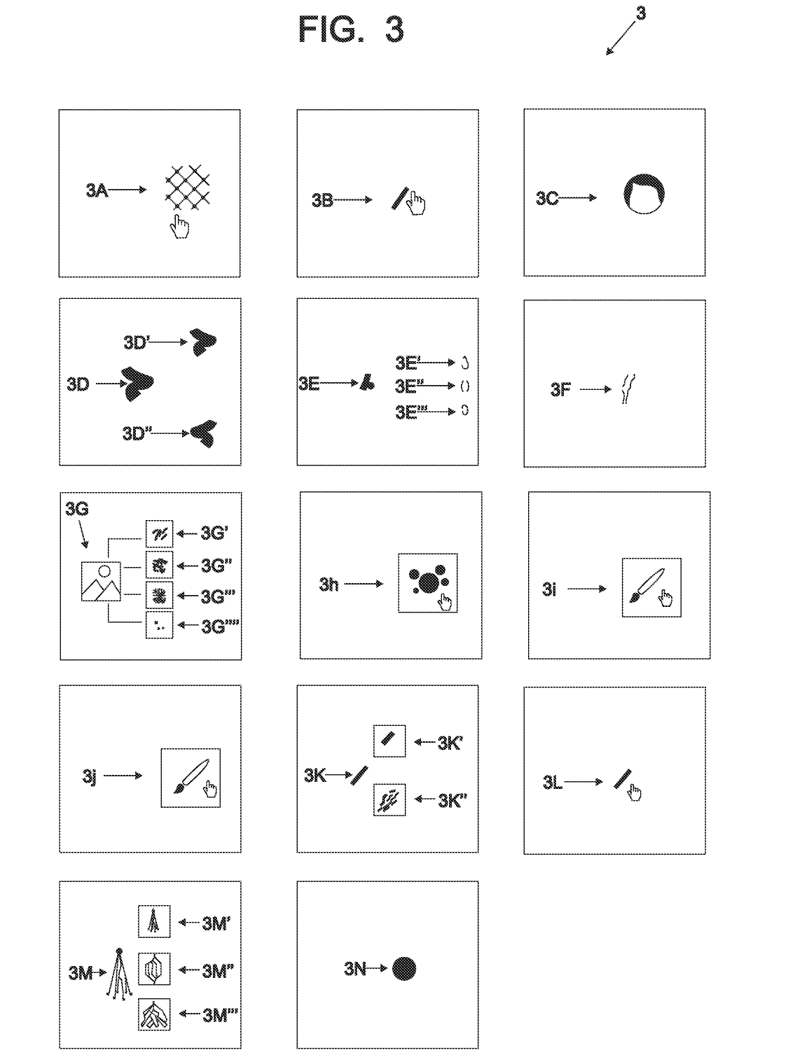

FIG. 4—Front view of the system for the preparation and storage of reports and examinations clinical and ultrasound digital vascular cartography, showing the layout of the arterial cartography the digestive arteries;

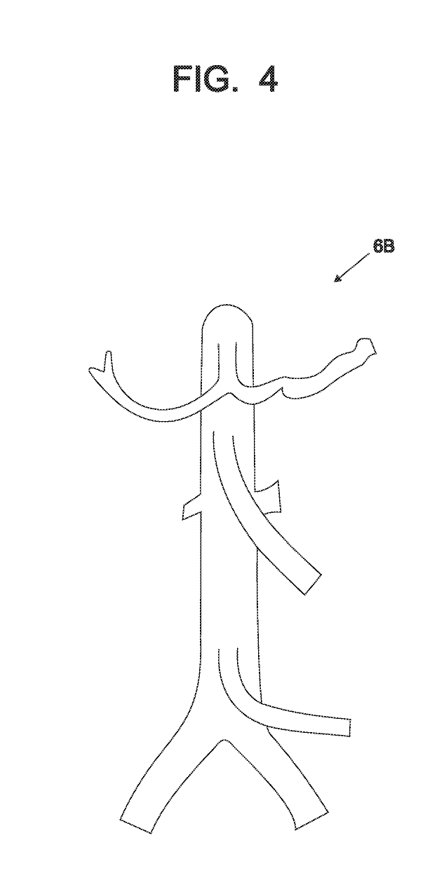

FIG. 5—Front view of the system for the preparation and storage of reports and examinations clinical and ultrasound digital vascular cartography, showing the layout of the carotid and vertebral arteries cartography, with cross-sectional detail view of the right and left carotid;

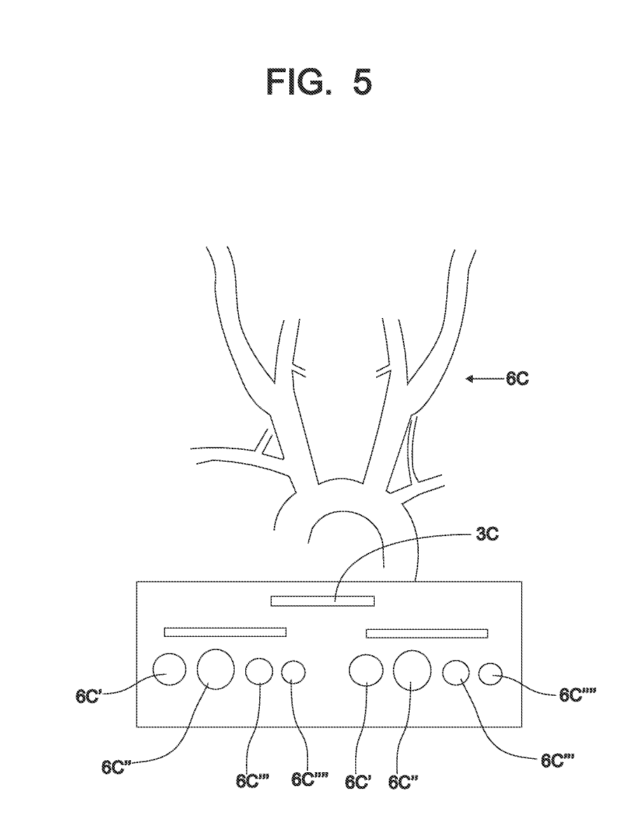

FIG. 6—Front view of the system for the preparation and storage of reports and examinations clinical and ultrasound digital vascular cartography, showing the layout of the arterial cartography showing the lower limbs;

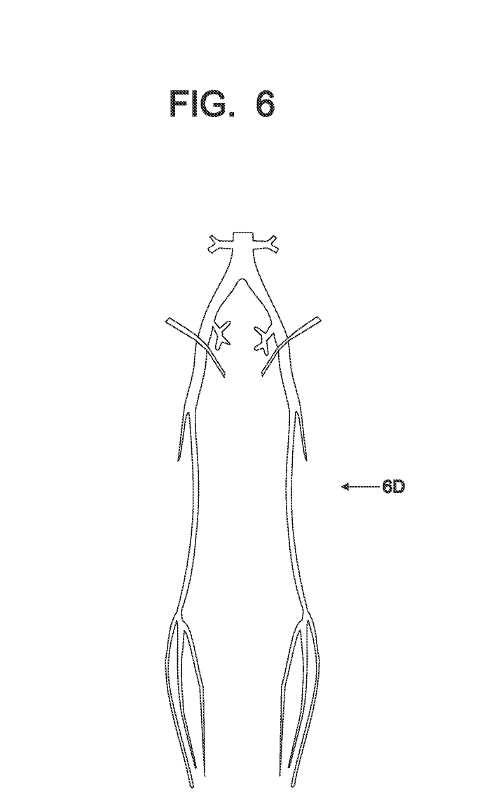

FIG. 7—Front view of the system for the preparation and storage of reports and examinations clinical and ultrasound digital vascular cartography, showing the layout of the arterial cartography showing the higher limbs;

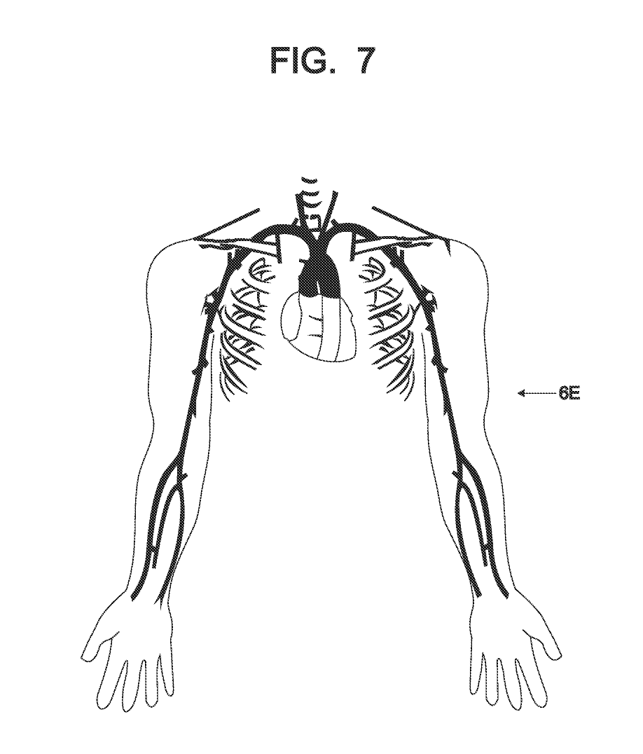

FIG. 8—Front view of the system for the preparation and storage of reports and examinations clinical and ultrasound digital vascular cartography, showing the layout of the arterial cartography showing the lower right limbs;

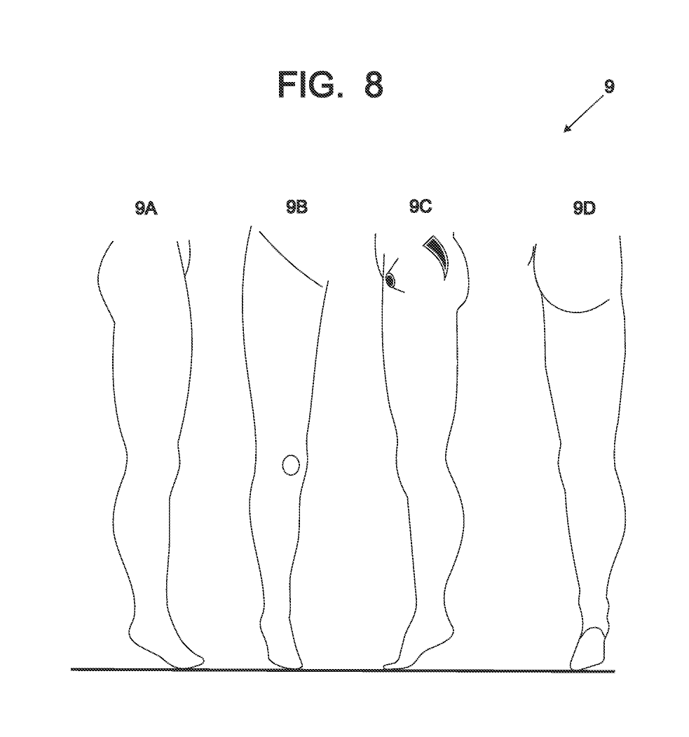

FIG. 9—Front view of the system for the preparation and storage of reports and examinations clinical and ultrasound digital vascular cartography, showing the layout of the arterial cartography showing the lower left limbs;

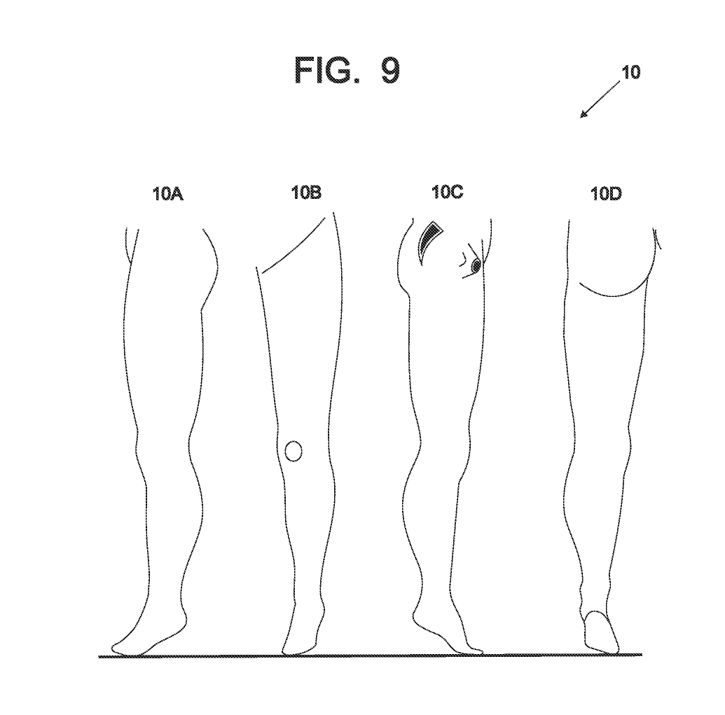

FIG. 10—Front view of the system for the preparation and storage of reports and examinations clinical and ultrasound digital vascular cartography, showing the layout of the venal cartography showing the lower limbs;

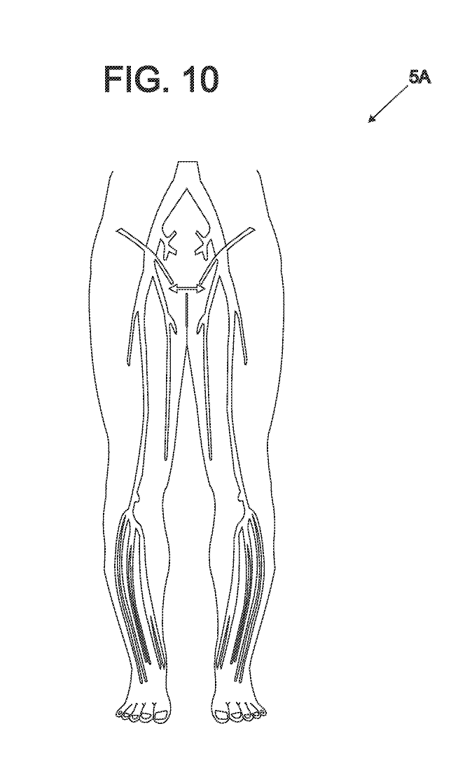

FIG. 11—Front view of the system for the preparation and storage of reports and examinations clinical and ultrasound digital vascular cartography, showing the layout of the venal cartography showing the higher limbs;

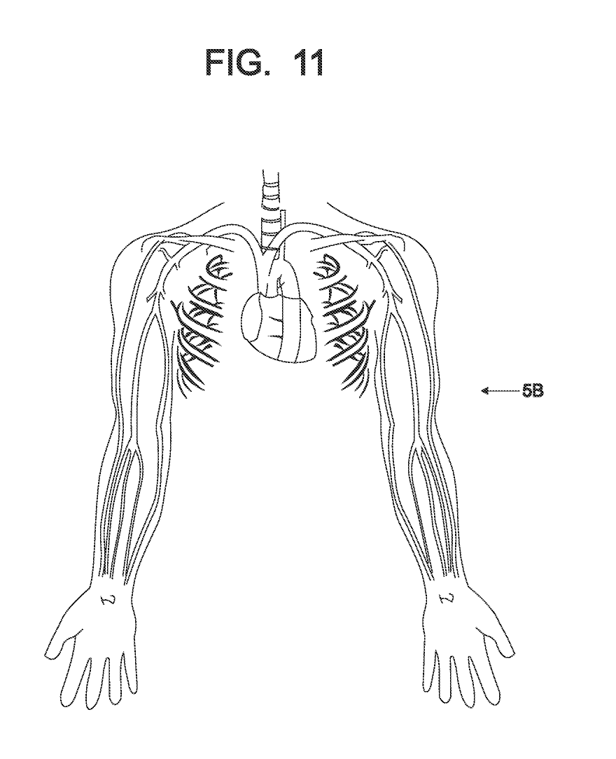

FIG. 12—Front view of the system for the preparation and storage of reports and examinations clinical and ultrasound digital vascular cartography, showing the layout of the venal cartography of the cava and iliac vein;

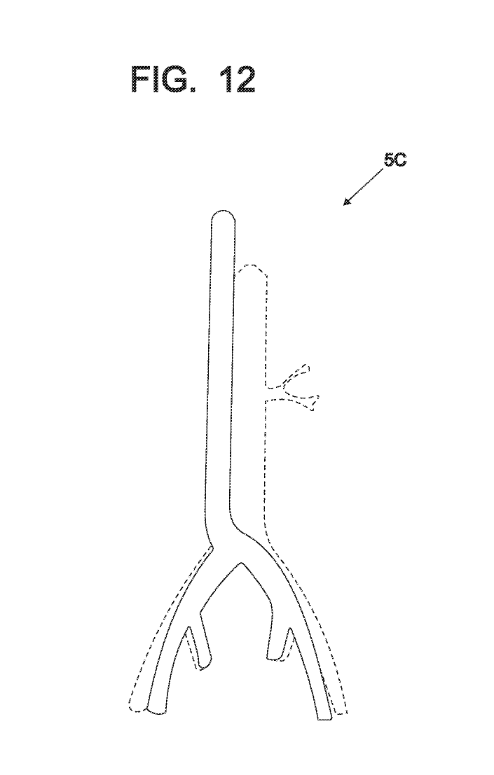

FIG. 13—Front view of the system for the preparation and storage of reports and examinations clinical and ultrasound digital vascular cartography, showing the layout of the venal cartography of the lower right limbs;

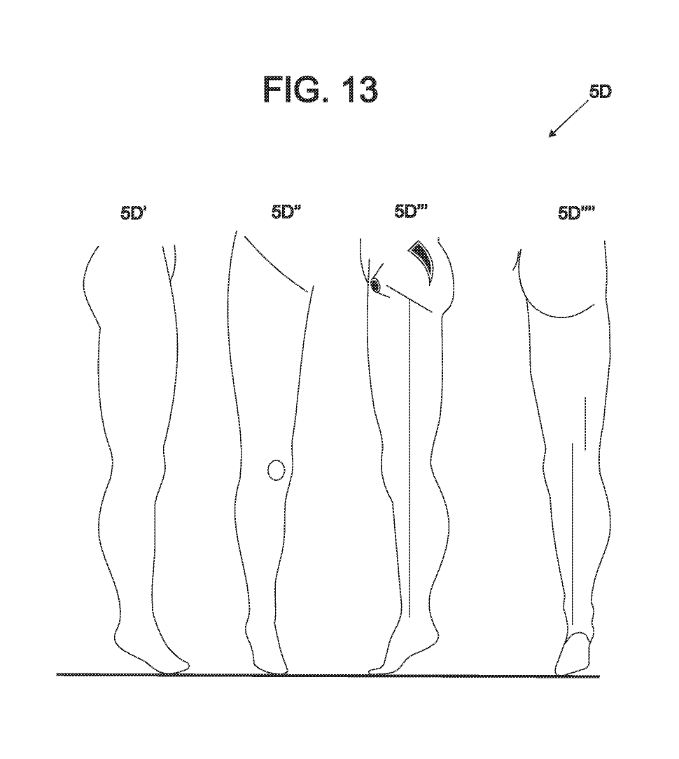

FIG. 14—Front view of the system for the preparation and storage of reports and examinations clinical and ultrasound digital vascular cartography, showing the layout of the venal cartography of the lower left limbs;

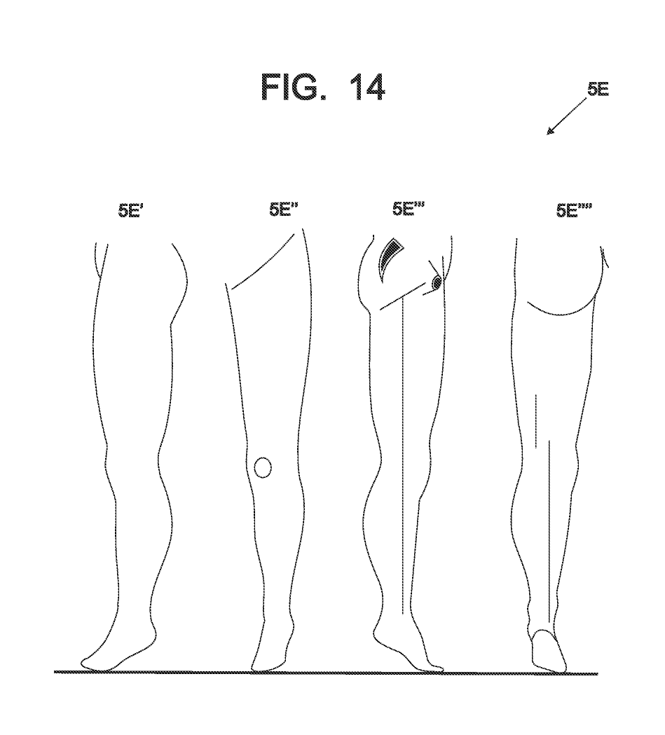

FIG. 15—Front view of the system for the preparation and storage of reports and examinations clinical and ultrasound digital vascular cartography, showing the scheme after consultation with the inclusion of drawings of the cartography of carotid and vertebral artery;

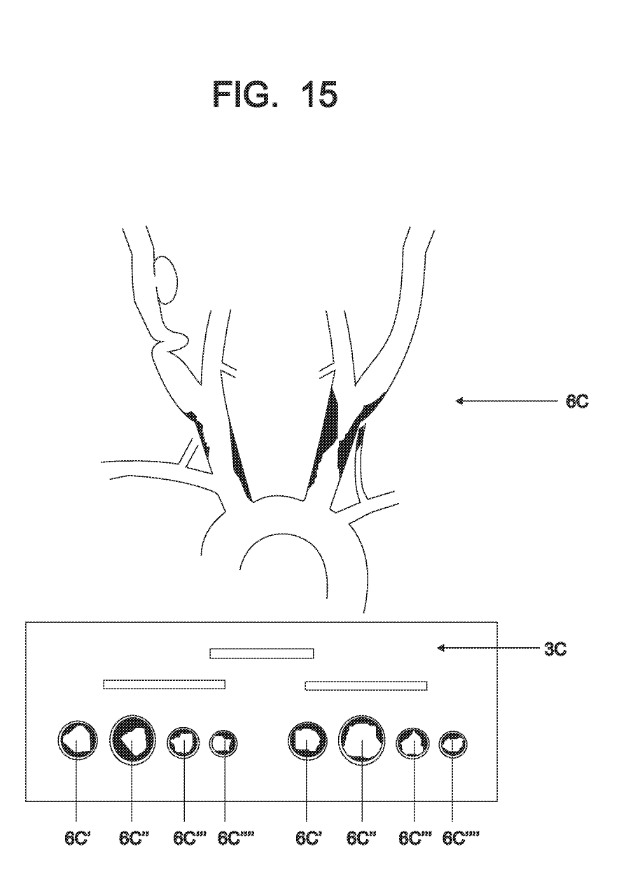

FIG. 16—Front view of the system for the preparation and storage of reports and examinations clinical and ultrasound digital vascular cartography, showing the scheme after consultation with the inclusion of drawings of the cartography of the lower right limb;

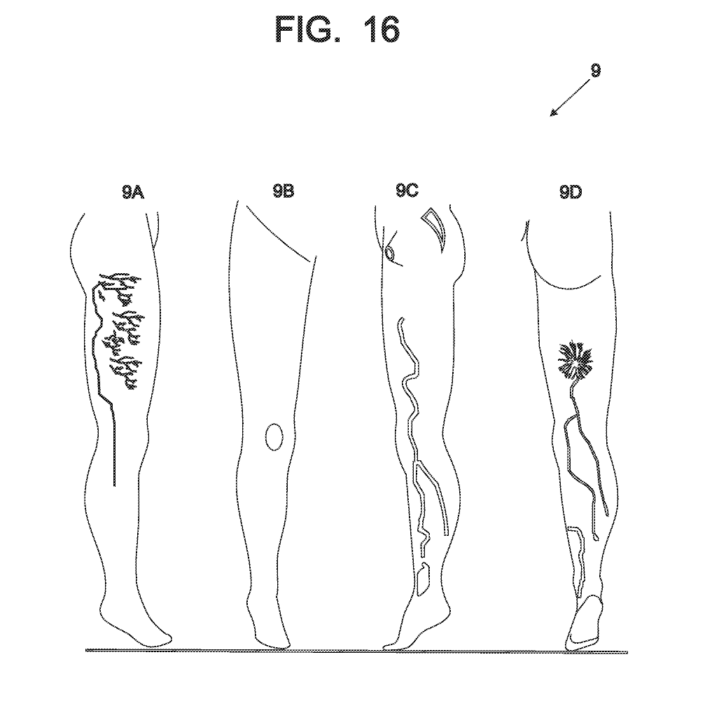

FIG. 17—Front view of the system for the preparation and storage of reports and examinations clinical and ultrasound digital vascular cartography, showing the scheme after consultation with the inclusion of drawings of the cartography of arterial cartography of the digestive arterial;

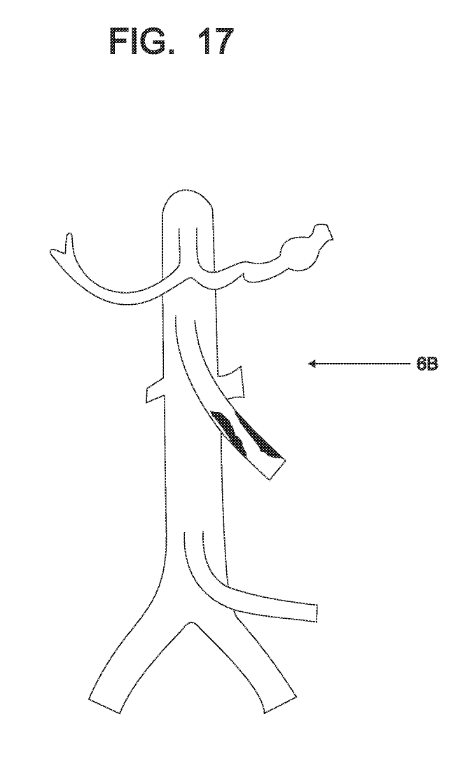

FIG. 18—Front view of the system for the preparation and storage of reports and examinations clinical and ultrasound digital vascular cartography, showing the scheme after consultation with the inclusion of drawings of the arterial cartography of the abdominal aortic and iliac;

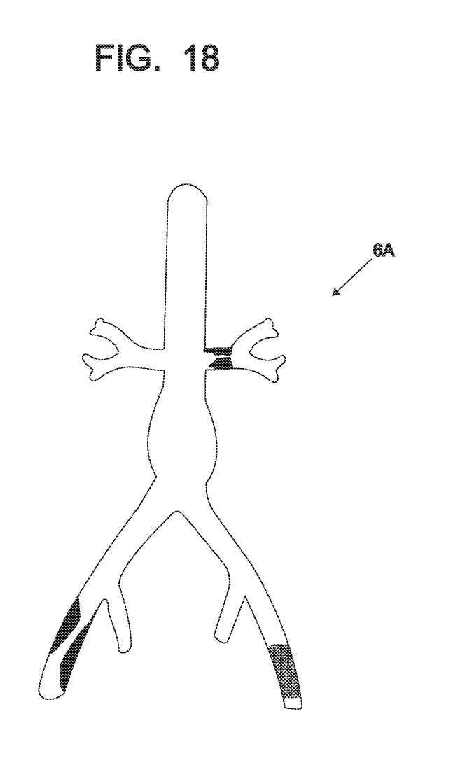

FIG. 19—Flowchart of the System for preparation and storage of digital reports and examination results of clinical and ultrasound vascular cartography.

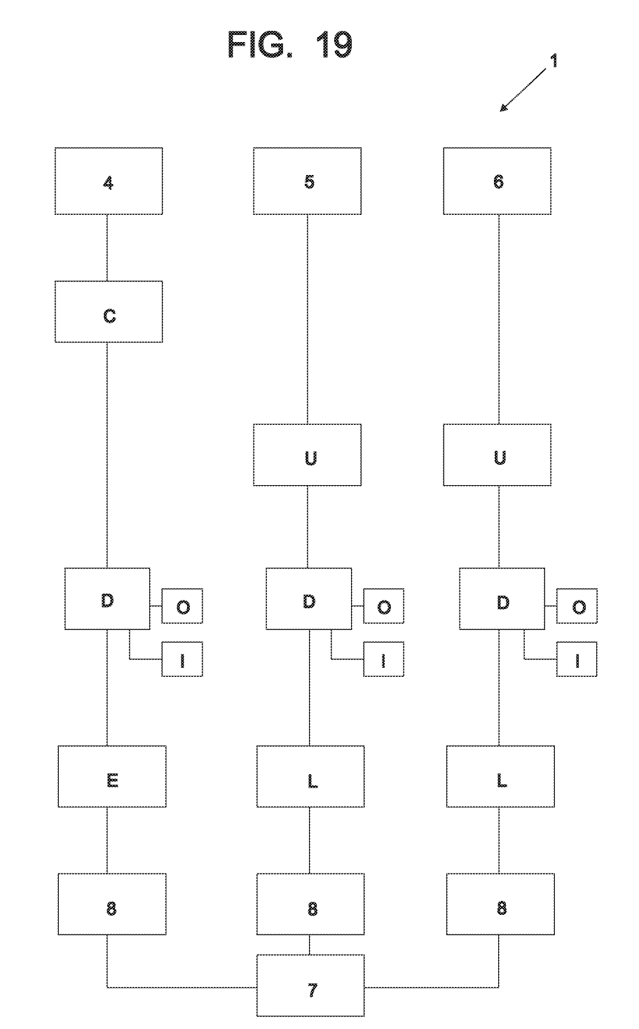

### DETAILED DESCRIPTION

The system for preparation and storage of digital reports and examination results of clinical and ultrasound vascular cartography object of the request of this Invention Patent hereto refers to a system (1) with stationary tools (2) and special tools (3) to the schematic drawing of the modules: clinic cartography (4), venous cartography (5) and arterial cartography (6), storing in a database (7) which can be accessed patient history anytime using the communication network worldwide (8).

More particularly, the system (1) has pleaded stationary tools (2) to assist and facilitate the schematic drawing of abnormality of each module (4, 5 and 6) and the rubber (2a) composed of three sizes (2a′) (2a″) and (2a″′), aims to erase any drawing made in cartography schemes, undo (2b) undoes the last action in the schemes notes of the cartography (2c) allows several notes in the right positions (2c′) and left (2c″) in Schemes brush of the cartography (2d) in three options of sizes (2d′), (2d″) and (2d″′) aims to make freehand drawings, line (2e) includes the option to choose three straight lines gauges (2e′), (2e″) and (2e′″), and color (2f) has several shades of colors to easily identify account for different situations, for example, normal plate occlusion, venous system, non allowed segment, segment thrombosis, reflux segment, among others, in addition to reducing tools (2g), enlarge (2h) and print (2i), fixed all these tools (2) are contained in all cartography schemes modules (4, 5 and 6).

In turn, the specific tools (3) correspond to stent “expander” (3a) has a characteristic mark its location in the schematic, atheroma/obstruction (3b) also has the function of locating scheme in which such irregularity is located, vision transverse plate (3c) is intended to mark the atheromatous plaque with transversal view, “kinking” fold (3d) used to mark a bend that can be determined from the left (3d′) or right (3d″) side, aneurysm (3e) has as purpose to register three types of aneurysms, saccular aneurysm (3e′), fusiform aneurysm (3e″) and pseudo aneurysm (3e′″), AV fistula (3f) records the location of the fistula in the scheme, microvarices (3g) is composed of four types of varicose veins and simple spider veins (3g′), microvarices arboriform (3g″), spider veins (3g′″) and micro papular (3g″″), dermatitis ocher (3h) has a characteristic to pose chronic venous insufficiency of the lower limbs, trunk varicose veins (3i) allows registering trunk varicose veins in cartography schemes, reticular varices (3j) records the reticular varicose veins in the drawings, venous thrombus (3K) register allows the venous thrombus recent (3K′) and late venous thrombus (3K″) schemes in cartography reflux (3L) admits register reflux in cartography schemes, vena cava filter (3M) aims to record the three types of filters (3M′), (3M″) and (3M″′) in scheme cartography vena cava and perforating (3N) objective penetrative in said register cartography schemes.

The module scheme clinic cartography (4) consists of fixed schemes of the lower limbs that can be drawn (D) all types of varicosities of the patient during medical consultation (C), as the microvarices (3g), reticular varices (3j), the trunk (3i), among others, besides recording the CEAP clinical classification and also include observations (O) and images (I) in the exam (E).

Fixed schemes on the clinic cartography module are: right lower limb (9) presented in lateral (9a), anterior (9b), opposite side (9c) and posterior (9d), the left lower limb (10) shown in lateral (10a), anterior (10b), opposite side (10c) and rear (10d).

The schema module venous ultrasonography cartography (5) has schemes like fixed: lower limbs (5a), upper limbs (5b), vena cava and iliac (5c), lower limb (5d) showing views lateral (5d′), anterior (5d″), opposite side (5d″′) and posterior (5d″″); lower left limb (5e) showing views: lateral (5e′), anterior (5e″), lateral opposite (5e″′) and posterior (5e″″).

The ultrasound venous cartography (5), after examination with ultrasound vascular apparatus (U), allows mounting reports (L) of the lower limbs to complete cartography schematic showing the presence of reflux superficial and/or deep presence of varicose veins, trophic changes as stasis dermatitis and ulcers in the distal third of the leg. There is still the availability of researching of deep vein thrombosis with vascular ultrasound in allowing the registration scheme, showing the presence of thrombus or late within the deep or superficial veins or the lower or higher limbs.

The ultrasonography arterial cartography (6) consists of fixed schemas which are: abdominal aorta and iliac arteries (6a), digestive arteries (6b), carotid and vertebral (6c) with a detail cross-sectional view of the right and left carotid and ACC (6c′), bifurcation (6c″), ICA (6c′″) and ACE (6c″″); lower (6d) and upper limbs (6e).

The arterial Ultrasound cartography, after the use of an ultrasonic device (U), permits also mounting reports (L) of the region of the carotid and abdominal aorta ends, recording the changes as atheromatous plaques, aneurysms, arteriovenous fistulas, and kinking.

The history of the patients is stored in a database (7) virtual encrypted form and will only be accessed via username and password through personal communication network worldwide (8).

Therefore, this application for patent is of novelty and inventive step thanks to the possibility of conducting examinations and reports stored in digital virtual database can even be edited, viewed and still guarantee the printing of reports/exams anywhere in the world by global communication network, which added industrial application is worthy of the privilege of patent.

What is claimed is:

1. System for preparation and storage of digital reports and examination results of clinical and ultrasound vascular cartography hereto refers to a system (1) with stationary tools (2) and special tools (3) to draw in the schematic of the modules: a clinic cartography (4), a venous cartography (5) and an arterial cartography (6), with storing in a database (7), which the patient history can be accessed anytime by using the global communication network (8).

2. System for preparation and storage of digital reports and examination results of clinical and ultrasound vascular cartography according to the claim 1, wherein the system (1) has stationary tools (2), consisting of rubber (2a) of three sizes (2a′), (2a″) and (2a′″), undo (2b), annotations (2c), to right (2c′) and to left (2c″), brush (2d) of sizes (2d′), (2d″) and (2d″′), line (2e) in the thickness (2e′), (2e″) and (2e′″), color (2f), reduce (2g), extend (2h) and printing (2i), contained in all the modules of the cartographic schemes (4, 5 and 6).

3. System for preparation and storage of digital reports and examination results of clinical and ultrasound vascular cartography, according to claim 1, wherein the system (1) possess specific tools (3), which are “expander” stent (3rd), atheroma/obstruction plate (3b), cross-sectional view plate (3c) “bend” kinking (3d) left (3d′) or right (3d″) sides, aneurysm (3e), saccular aneurysm (3e′), fusiform aneurysm (3e″) and pseudo aneurysm (3e′″), AV fistula (3f), microvarices (3g), being simple microvarices (3g′), arboriform microvarices (3g″), spider microvarices (3g′″) and papular microvarices (3g″″), ochrodermatitis (3h), trunk varicose veins (3i), reticular varices (3j), venous thrombosis (3K) recent (3K′) and late (3H″), reflux (3L), vena cava filter (3M), (3M′), (3M″) and (3M″′), and perforating (3N).

4. System for preparation and storage of digital reports and examination results of clinical and ultrasound vascular cartography” according to claim 1, wherein the scheme module of clinical cartography (4) consist of schemes, which may be drawn (D) all types of varicosity of the patient during medical examination (C), as the microvarices (3g), reticular varices (3j) and even the trunk varices (3i), and to record the clinical classification CEAP, VILLALTA SCALE and CAPRINI SCALE, as well as include observations (O) and images (I) in the exam (E).

5. System for preparation and storage of digital reports and examination results of clinical and ultrasound vascular cartography, according to claims 1 and 4, wherein the fixed schemes of the clinical cartography module (4) are a right lower limb (9), with lateral (9a), anterior (9b), opposite side (9c) and rear (9d) views; left lower limbs (10) in the lateral (10a), anterior (10b), opposite side (10c) and rear (10d) views.

6. System for preparation and storage of digital reports and examination results of clinical and ultrasound vascular cartography, according to claim 1, wherein the scheme module of the venous ultrasound cartography (5) has fixed schemes of the lower limbs (5a), upper limbs (5b), vena cava and iliac (5c), right lower limb (5d), in lateral (5d′), anterior (5d″), opposite side (5d′″) and posterior (5d″″) views, left lower limb (5e) in lateral (5e′), anterior (5e″), opposite side (5e′″) and posterior (5e″″) views.

7. System for preparation and storage of digital reports and examination results of clinical and ultrasound vascular cartography, according to claims 1 and 6, wherein the venous ultrasound cartography (5) uses a vascular ultrasound device (U) for mounting reports (L).

8. System for preparation and storage of digital reports and examination results of clinical and ultrasound vascular cartography, according to claim 1, wherein the ultrasound arterial cartography (6) consists of fixed schemes of the abdominal and iliac aortas arteries (6a), digestive arteries (6b), carotid and vertebral arteries (6c), with detail of the cross-sectional view to the right and left carotids, being ACC (6c′), bifurcation (6c″), ACI (6c′″) and ACE (6c″″); lower limbs (6d) and upper limbs (6e).

9. System for preparation and storage of digital reports and examination results of clinical and ultrasound vascular cartography, according to claims 1, 2, 3, 4, 5, 6, 7 and 8, wherein elements can be collected to allow the drawing (D) in the diagrams of each module (4, 5 and 6).

10. System for preparation and storage of digital reports and examination results of clinical and ultrasound vascular cartography, according to claim 1, wherein it permits the inclusion of observations (O) and images (I) in tests (E), and reports (L).

11. System for preparation and storage of digital reports and examination results of clinical and ultrasound vascular cartography, according to claim 1, wherein the historical of the patient is stored in a virtual and encrypted database (7).

12. System for preparation and storage of digital reports and examination results of clinical and ultrasound vascular cartography, according to claims 1 and 11, wherein the access is possible only with personal user name and password in a specific site.

13. System for preparation and storage of digital reports and examination results of clinical and ultrasound vascular cartography, according to claims 1, 11 and 12, wherein the access to the system (1) is possible only through the global communication network (8).
